(19) United States
(12) Patent Application Publication
(10) Pub. No.: US 2012/0206755 A1
(43) Pub. Date: Aug. 16, 2012

(54) IMAGE FORMING APPARATUS

(75) Inventor: Takehisa NAKAO, Toyokawa-shi (JP)

(73) Assignee: Konica Minolta Business Technologies, Inc., Chiyoda-ku (JP)

(21) Appl. No.: 13/358,144

(22) Filed: Jan. 25, 2012

(30) Foreign Application Priority Data
Feb. 14, 2011 (JP) 2011-028304

(51) Int. Cl. G06K 15/02

(52) U.S. Cl. 358/1.14; 358/1.16

(57) ABSTRACT

An image forming apparatus including an ASIC provided with two functional modules that are reset together by a reset signal. The image forming apparatus stores data used for processing by the functional modules, detects errors in the functional modules, and monitors an execution state of the functional modules. When detecting an error in one of the functional modules, the image forming apparatus acquires the execution state of the other functional module in which no error is detected. When the other functional module is not currently operating, the image forming apparatus resets the ASIC by a reset signal, and when the other functional module is currently operating, the image forming apparatus suppresses resetting of the ASIC until the other functional module finishes operating and then resets the ASIC by a reset signal.

### CROSS-REFERENCE TO RELATED APPLICATIONS

This application is based on application No. 2011-28304 filed in Japan, the contents of which are hereby incorporated by reference.

### BACKGROUND OF THE INVENTION

(1) Field of the Invention

The present invention relates to image forming apparatuses that use ASICs, and in particular to technology for controlling a reset upon the occurrence of an error in an ASIC provided with a plurality of functional modules.

(2) Related Art

In image forming apparatuses, such as digital copiers, that have functions such as faxing, copying, and printing, a portion of the processing performed by the image forming apparatus is executed using an Application Specific Integrated Circuit (ASIC) in order to reduce the processing load on the CPU, and to perform a variety of complex processes efficiently and rapidly. For example, processes that are performed using an ASIC include compression processing to compress image data that is input into the image forming apparatus and store the data in image memory, and expansion processing to expand compressed image data in order to print the image data.

Furthermore, in recent years, in order to reduce costs by reducing the number of components, one ASIC is provided with a plurality of functional modules, in order for one ASIC to perform a plurality of processes via the functional modules (see Japanese Patent Application Publication No. 2008-182671). When an error is detected in any of the functional modules, either the entire system is reset (see Japanese Patent Application Publication No. 2006-121177), or the ASIC is reset. This allows the functional module in which the error occurred to be restored to a proper state of functioning.

With the above conventional technology, however, an ASIC that is provided with a plurality of functional modules is reset when an error occurs in any one of the functional modules, even if no error has occurred in the other functional modules. As a result, all of the functional modules are reset. Any of the other functional modules that were in the middle of processing thus need to begin the processing again from the start after the reset, thus causing the problem that the processing before the reset is wasted.

### SUMMARY OF THE INVENTION

The present invention has been conceived in light of the above problem, and it is an object thereof to provide an image forming apparatus, comprising an ASIC provided with a plurality of functional modules, that prevents functional modules in which an error does not occur from repeating processing that was in progress when an error occurs in one of the functional modules in the ASIC, and that avoids wasting processing that is performed up until the occurrence of the error by the functional modules in which the error does not occur.

In order to solve the above problem, an image forming apparatus according to an aspect of the present invention includes an ASIC provided with a first functional module and a second functional module that are reset together by a reset signal, the image forming apparatus comprising: a memory for storing data used for processing by the first functional module and data used for processing by the second functional module; an error detection unit configured to detect an error in the first functional module and an error in the second functional module; a monitoring unit configured to monitor an execution state of the first functional module and an execution state of the second functional module; a determination unit configured to acquire from the monitoring unit, when the error detection unit detects an error in only one of the first functional module and the second functional module, the execution state of the other functional module in which no error is detected, and to determine whether the other functional module is currently operating; and a reset controller configured (i) to reset the ASIC by transmitting a reset signal to the ASIC when the determination unit determines that the other functional module is not currently operating, and (ii) to suppress resetting of the ASIC, when the determination unit determines that the other functional module is currently operating, until the other functional module finishes operating and, after the other functional module finishes operating, to reset the ASIC by transmitting a reset signal to the ASIC.

The first functional module may be a compression module that compresses image data, and the second functional module may be an expansion module that expands compressed image data.

### BRIEF DESCRIPTION OF THE DRAWINGS

These and other objects, advantages and features of the invention will become apparent from the following description thereof taken in conjunction with the accompanying drawings those illustrate a specific embodiments of the invention.

In the drawings:

FIG. 1 shows the main structure of an image forming apparatus 1;

FIG. 2 shows the detailed structure of the image control ASIC 107;

FIG. 3 is a flowchart showing operations by a CPU 101 for ASIC reset control;

FIG. 4 is a flowchart showing operations by the CPU 101 for reset delay; and

FIG. 5 is a flowchart showing a modification to processing for a reset delay.

### DESCRIPTION OF PREFERRED EMBODIMENTS

The following describes an embodiment of the present invention with reference to the drawings.

### Structure

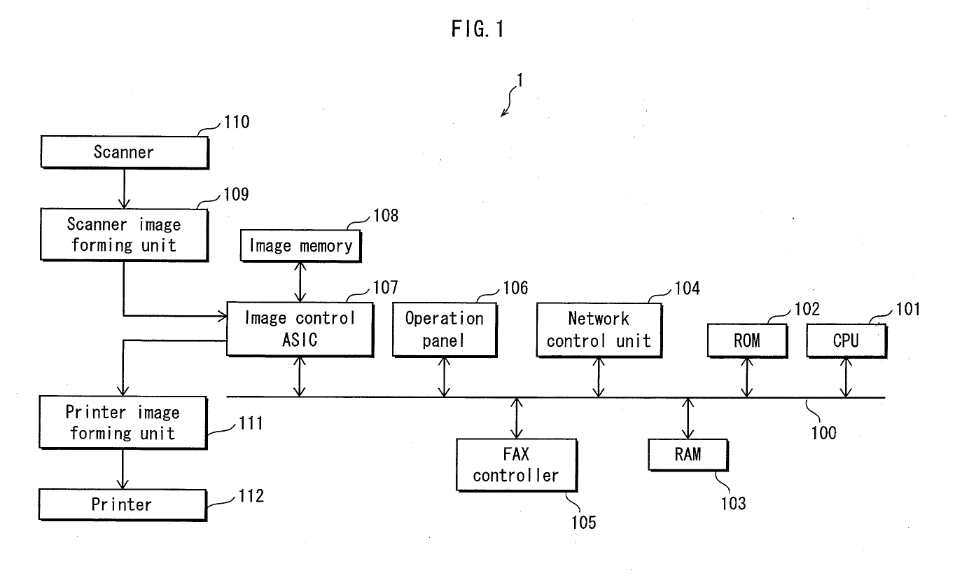

FIG. 1 shows the main structure of an image forming apparatus 1 according to an embodiment of the present invention. The image forming apparatus 1 is provided with a CPU 101, a ROM 102, a RAM 103, a network control unit 104, a FAX controller 105, an operation panel 106, an image control ASIC 107, an image memory 108, a scanner image forming unit 109, a scanner 110, a printer image forming unit 111, a printer 112, and the like. The ROM 102, the RAM 103, the network control unit 104, the FAX controller 105, the operation panel 106, and the image control ASIC 107 are each connected to the CPU 101 via an I/O bus.

The CPU 101 controls the entire image forming apparatus 1 by executing programs stored in the ROM 102. The CPU 101 also performs the ASIC reset control described below. The RAM 103 is used as a work area during program execution by the CPU 101.

The RAM 103 also temporarily stores image data output by the scanner image forming unit 109 after binarization. The network control unit 104 has the function of controlling communication with a variety of external devices to which the image forming apparatus 1 is connected over a network such as a Local Area Network (LAN).

The FAX controller 105 is a composed of a modem, a Network Control Unit (NCU), or the like, and performs functions such as modulation during transmission and reception of a facsimile, control of a transmission protocol, connection to a telephone line, and the like. The operation panel 106 is composed of a plurality of input keys, a liquid crystal display, and the like. A touch panel is layered on the surface of the liquid crystal display. The operation panel 106 has the function of receiving a variety of instructions from a user through touch input via the touch panel or key input via the input keys.

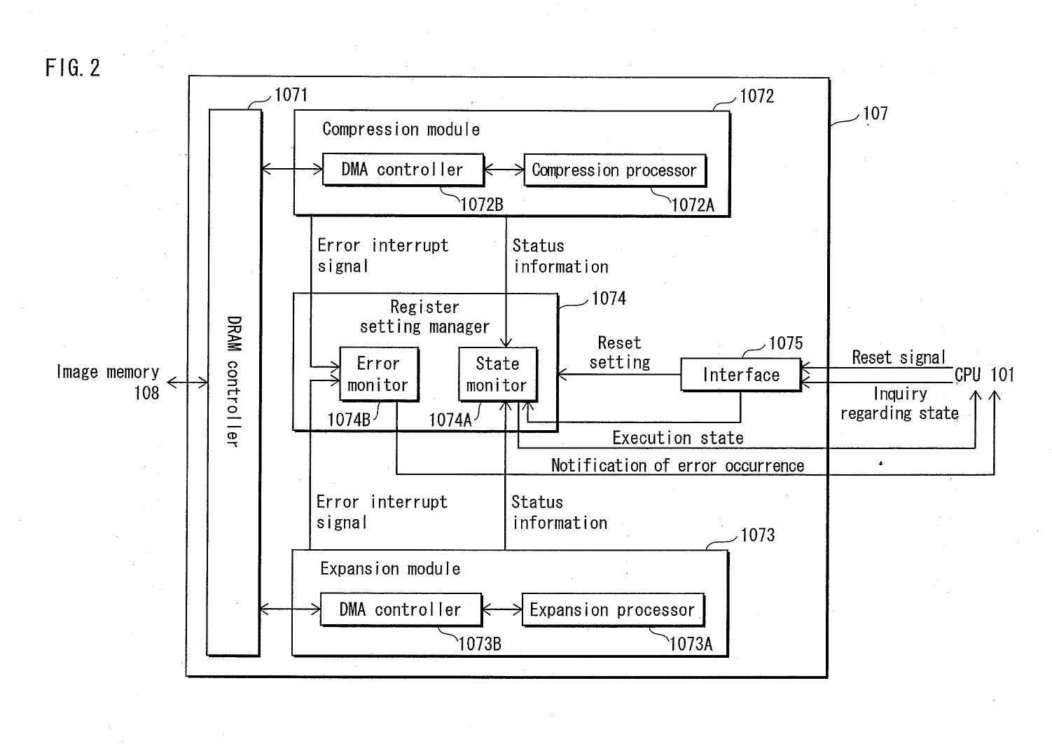

The image control ASIC 107 performs compression processing to compress image data that has been read by the scanner 110 and converted to binary form by the scanner image forming unit 109. The image control ASIC 107 also performs expansion processing to expand compressed image data and image data that is input from an external PC via the network. FIG. 2 shows the detailed structure of the image control ASIC 107. As shown in FIG. 2, the image control ASIC 107 includes a DRAM controller 1071, a compression module 1072, an expansion module 1073, a register setting manager 1074, and the like.

The DRAM controller 1071 controls the writing of image data into the image memory 108 and the reading of image data from the image memory 108. The compression module 1072 includes a compression processor 1072A and a DMA controller 1072B. Image data, which has been converted into binary form by the scanner image forming unit 109, is transferred via Direct Memory Access (DMA) by the DMA controller 1072B from the RAM 103 a predetermined amount at a time (for example, one page of image data at a time) and is written into the image memory 108 by the DRAM controller 1071. Subsequently, the image data is sequentially read by the compression module 1072 in predetermined data units (for example, in units of four pixels of image data) from the image memory 108 and is compressed by the compression processor 1072A. The compressed image data is then transferred via DMA by the DMA controller 1072B and is written into the image memory 108 by the DRAM controller 1071.

The expansion module 1073 includes an expansion processor 1073A and a DMA controller 1073B. Compressed image data that is stored in the image memory 108 is sequentially read by the DMA controller 1073B via the DRAM controller 1071 in the data units by which the image data was compressed (for example, in units of four pixels of image data) and transferred by DMA to the expansion processor 1073A. The compressed image data transferred by DMA is then sequentially expanded by the expansion processor 1073A and output to the printer image forming unit 111.

The register setting manager 1074 has an internal register. In the register, the register setting manager 1074 sets parameters for causing the functional modules in the compression module 1072 and the expansion module 1073 to perform predetermined processing. The set parameters are communicated to the corresponding functional modules. Each functional module performs predetermined processing by referring to the communicated parameters.

Furthermore, the register setting manager 1074 includes a state monitor 1074A, an error monitor 1074B, and the like and is connected to an interface 1075 for communicating with the CPU 101. The state monitor 1074A monitors the execution state of the functional modules in the compression module 1072 and the expansion module 1073 and sets a value in the internal register to indicate whether each of these functional modules is currently operating. Specifically, the state monitor 1074A monitors the execution state by acquiring status information from each functional module indicating the execution state of the functional module. When receiving an inquiry from the CPU 101 into the execution state of a functional module via the interface 1075, the state monitor 1074A notifies the CPU 101 of the execution state of the corresponding functional module.

The error monitor 1074B monitors for the occurrence of errors in the functional modules in the compression module 1072 and the expansion module 1073 and sets, in the internal register, a value indicating whether an error has occurred. Specifically, the error monitor 1074B monitors for the occurrence of errors in the functional modules by monitoring for input of an error interrupt signal output by the functional modules upon occurrence of an error. When an error occurs, the error monitor 1074B notifies the CPU 101 accordingly.

When a reset signal is input from the CPU 101 via the interface 1075, the register setting manager 1074 responds to the reset signal by setting the value of each register to an initial value and resetting the image control ASIC 107.

Returning to FIG. 1, the image memory 108 stores image data compressed by the image control ASIC 107. The scanner image forming unit 109 converts image data read by the scanner 110 to binary form after performing processing such as gamma correction, density conversion, filtering, scaling conversion, error diffusion, and the like. The scanner 110 reads an original image, generates image data based on the original image, and outputs the image data to the scanner image forming unit 109.

The printer image forming unit 111 performs image processing such as predetermined edge enhancement, smoothing, tone reproduction, and the like on the image data expanded by the image control ASIC 107 and outputs the result to the printer 112. Based on the image data input from the printer image forming unit 111, the printer 112 forms an image on a recording sheet and outputs the recording sheet.

### Operations

### ASIC Reset Control

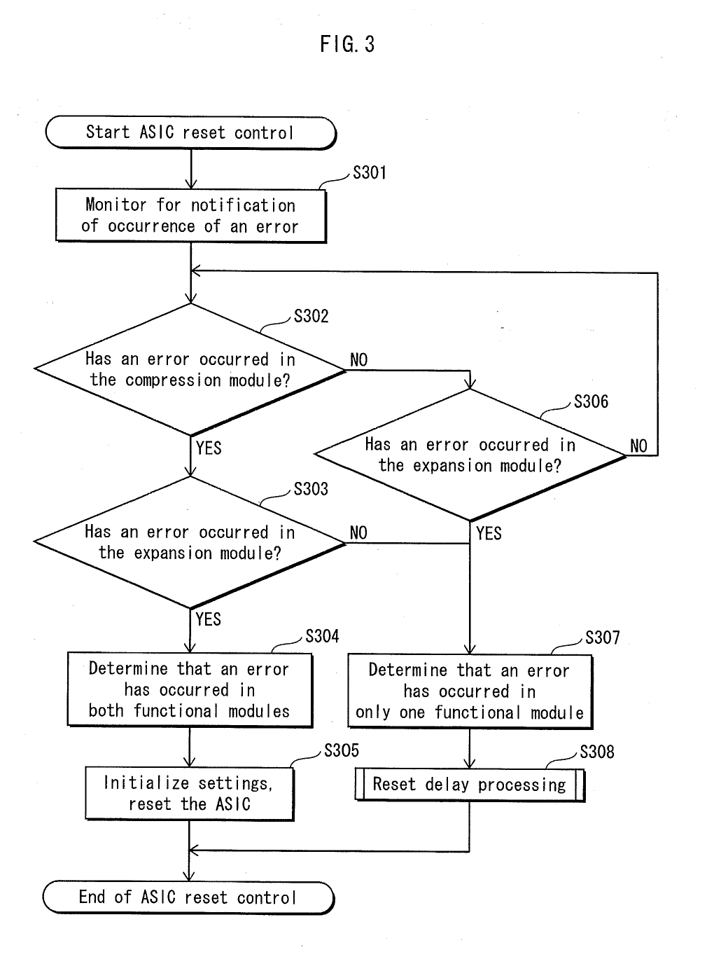

FIG. 3 is a flowchart showing operations by a CPU 101 for ASIC reset control; After processing for ASIC reset control is initiated, the CPU 101 monitors for notification of the occurrence of an error in each of the functional modules (the compression module 1072 and the expansion module 1073) in the image control ASIC 107 (step S301).

If notification of the occurrence of an error in the compression module 1072 in the image control ASIC 107 has been received (step s302: YES), the CPU 101 further determines whether notification of the occurrence of an error in the expansion module 1073 of the image control ASIC 107 has been received (step S303).

If notification of the occurrence of an error in the expansion module 1073 has also been received (step S303: YES), the CPU 101 determines that an error has occurred in both of the functional modules of the image control ASIC 107 (step S304). The CPU 101 then transmits a reset signal to the image control ASIC 107, resets the value of each register of the image control ASIC 107 to the initial value, and resets the image control ASIC 107 (step S305).

On the other hand, if the determination result of step S303 is negative (step S303: NO), the CPU 101 determines that an error has only occurred in one of the functional modules of the image control ASIC 107 (step S307) and performs processing for a reset delay as described below (step S308).

If the determination result of step S302 is negative (step S302: NO), the CPU 101 further determines whether notification of the occurrence of an error in the expansion module 1073 of the image control ASIC 107 has been received (step S306). If the determination result of step S306 is positive (step S306: YES), processing by the CPU 101 proceeds to step S307. If the determination result of step S306 is negative (step S306: NO), the CPU 101 determines that no error has occurred in either of the functional modules of the image control ASIC 107, and processing returns to step S302.

### Processing for Reset Delay

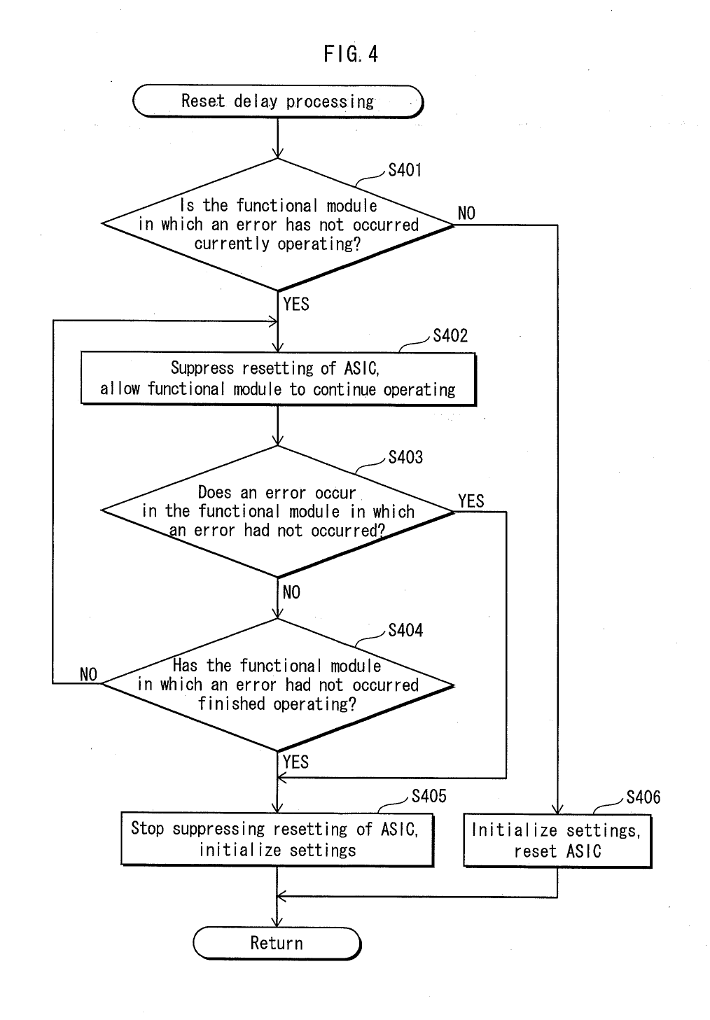

FIG. 4 is a flowchart showing operations by the CPU 101 for reset delay. When notification of the occurrence of an error has only been received for one of the functional modules in the image control ASIC 107 (step S302: YES and step S303: NO, or step S302: NO and step S306: YES), the CPU 101 transmits an inquiry to the image control ASIC 107 regarding the execution state of the functional module in which an error has not occurred. The CPU 101 then determines whether this functional module is currently operating (step S401).

When the functional module in which an error has not occurred is not currently operating (step S401: NO), the CPU 101 transmits a reset signal to the image control ASIC 107 to reset the value of each register of the image control ASIC 107 to the initial value and to reset the image control ASIC 107 (step S406). When the functional module in which an error has not occurred is currently operating (step S401: YES), the CPU 101 suppresses the reset of the image control ASIC 107, allowing the functional module to continue operating (step S402). The CPU 101 then monitors the execution state of the functional module by periodically transmitting an inquiry to the image control ASIC 107 regarding the execution state of the functional module.

As the functional module in which an error has not occurred continues to operate, if no notification of the occurrence of an error is issued (step S403: NO) and the functional module completes its operations (step S404: YES), the CPU 101 stops suppressing the reset of the image control ASIC 107, transmitting a reset signal to the image control ASIC 107 to reset the value of each register of the image control ASIC 107 to the initial value and to reset the image control ASIC 107 (step S405).

If notification of the occurrence of an error is issued for the functional module in which no error had occurred before the functional module finishes its continued operations (step S403: YES, step S404: NO), processing by the CPU 101 proceeds to step S405 without waiting for the operations to be complete.

In this way, in an ASIC (image control ASIC 107) provided with a plurality of functional modules (compression module 1072, expansion module 1073) that can operate independently in parallel and that are all reset by a reset signal, when an error occurs in one of the functional modules, and the other functional module in which an error has not occurred is currently operating, the ASIC is reset after waiting for operations by the currently operating functional module to be complete. This prevents repetition of processing in progress by the functional module in which an error has not occurred, thus reducing the amount of processing wasted by the functional module.

### Supplementary Explanation

While an image forming apparatus 1 according to the present invention has been described based on an embodiment thereof, the present invention is of course in no way limited to the above embodiment.

(1) In the embodiment, the ASIC subject to ASIC reset control is the image control ASIC 107, but the ASIC is not limited to the image control ASIC 107 and may be any ASIC provided with a plurality of functional modules that can operate independently in parallel. For example, similar ASIC reset control as in the above embodiment may be performed on an ASIC provided with a functional module to perform the functions of the scanner image forming unit 109 and a functional module to perform the functions of the printer image forming unit 111.

Alternatively, similar ASIC reset control as in the above embodiment may be performed on an ASIC provided with a functional module to perform the functions of the network control unit 104 and a functional module to perform the functions of the FAX controller 105. Furthermore, the number of the ASICs provided with a plurality of functional modules is not limited to one. A plurality of ASICs may be adopted. Additionally, the number of functional modules included in one ASIC is not limited to two, but may be three or greater.

(2) In the above Embodiment, during processing for the reset delay, as long as no error occurs in the currently operating functional module in which no error had occurred, the reset of the image control ASIC 107 is suppressed until operations by the functional module are complete. If a predetermined event occurs while the reset is being suppressed, however, suppression of the reset may be stopped and the timing of the reset advanced.

For example, if an error occurs in the compression module 1072 of the image control ASIC 107 while the expansion module 1073 is in progress, and a FAX is received from an external source, the data transmitted by the FAX cannot be compressed while the reset of the image control ASIC 107 is being suppressed. The image forming apparatus 1 therefore cannot return to a state of being able to receive the FAX. As a result, the state of not being able to receive the FAX that has arrived continues, leading to the problem of a time out that causes the transmission of the FAX to be cut off partway through.

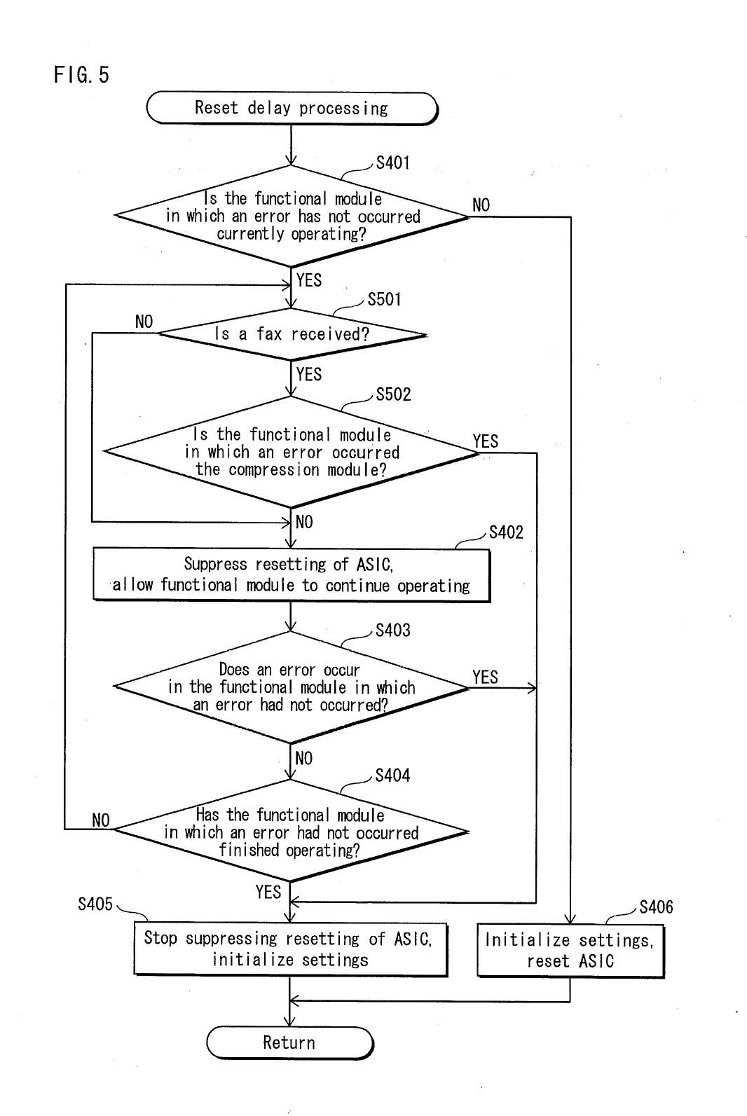

To avoid this sort of problem, when an error occurs in the compression module 1072 while the expansion module 1073 is operating and a FAX is subsequently received from an external source, suppression of the reset may be stopped, and as shown in FIG. 5, the timing of the reset may be advanced.

FIG. 5 is a flowchart showing a modification to processing for a reset delay. In FIG. 5, processing that is the same as the reset delay shown in FIG. 4 for the above embodiment is provided with the same step numbers as in FIG. 4. The following explanation focuses on the differences between the processing in FIG. 4 and FIG. 5.

When the functional module in which an error has not occurred is currently operating (step S401: YES), and a FAX is received by the FAX controller 105 from an external source (step S501: YES), the CPU 101 determines whether the functional module for which notification of the occurrence of an error was issued is the compression module 1072 (step S502).

If the functional module for which notification of the occurrence of an error was issued is the compression module 1072 (step S502: YES), processing proceeds to step S405. If the functional module for which notification of the occurrence of an error was issued is not the compression module 1072 (step S502: NO), processing proceeds to step S402.

With this structure, if an error occurs in the compression module 1072 and a FAX is received while the expansion module 1073 is operating, the image control ASIC 107 is reset without waiting for the expansion module 1073 to complete its operations. The compression module 1072 thus quickly returns to an operable state. This effectively prevents the problem of suppression of the reset continuing, which would prolong the state of not being able to receive the FAX, leading to the problem of a time out that causes the transmission of the FAX to be cut off partway through.

### SUMMARY

An image forming apparatus according to an embodiment of the present invention as described above includes an ASIC provided with a first functional module and a second functional module that are reset together by a reset signal, the image forming apparatus comprising: a memory for storing data used for processing by the first functional module and data used for processing by the second functional module; an error detection unit configured to detect an error in the first functional module and an error in the second functional module; a monitoring unit configured to monitor an execution state of the first functional module and an execution state of the second functional module; a determination unit configured to acquire from the monitoring unit, when the error detection unit detects an error in only one of the first functional module and the second functional module, the execution state of the other functional module in which no error is detected, and to determine whether the other functional module is currently operating; and a reset controller configured (i) to reset the ASIC by transmitting a reset signal to the ASIC when the determination unit determines that the other functional module is not currently operating, and (ii) to suppress resetting of the ASIC, when the determination unit determines that the other functional module is currently operating, until the other functional module finishes operating and, after the other functional module finishes operating, to reset the ASIC by transmitting a reset signal to the ASIC.

The first functional module may be a compression module that compresses image data, and the second functional module may be an expansion module that expands compressed image data.

An ASIC with the above structure is provided with two functional modules that are reset together by a reset signal. When an error is detected in one of the functional modules, and the other functional module in which no error occurs is currently operating, the ASIC is reset after waiting for the other functional module to finish operating. This structure therefore prevents repetition of processing in progress by the functional module in which an error has not occurred and thus avoids wasting processing by the functional module.

When the error detection unit detects an error in both the first functional module and the second functional module, the reset controller may reset the ASIC by transmitting the reset signal to the ASIC without waiting for a result of determination by the determination unit.

With this structure, when an error occurs in both functional modules, resetting of the ASIC is performed without being suppressed. This allows for rapid resolution of the errors in the functional modules, thereby returning both functional modules to an operable state.

When the determination unit determines that the other functional module in which no error is detected is currently operating, and subsequently an error is detected in the other functional module while the other functional module is continuing to operate, the reset controller may stop suppressing resetting of the ASIC and resets the ASIC by transmitting the reset signal to the ASIC.

With this structure, if an error is detected in the functional module that is being allowed to continue operating, suppression of resetting of the ASIC is stopped, and the ASIC is reset. This prevents resetting of the ASIC from being unnecessarily delayed.

The image forming apparatus may further comprise a facsimile reception function, wherein when an error is detected in the compression module and the expansion module is currently operating, and a fax arrives from an external source while the expansion module is continuing to operate, the reset controller stops suppressing resetting of the ASIC and resets the ASIC by transmitting the reset signal to the ASIC without waiting until the other expansion module finishes operating.

With this structure, between the two functional modules in the ASIC, when an error is detected in the compression module and the expansion module is currently operating, and a fax that needs to be processed by the compression module arrives, suppression of resetting of the ASIC is stopped and the ASIC is reset. This effectively prevents the problem of suppression of the reset continuing without exception until operations are complete by the expansion module that is currently operating, which would prolong the state of not being able to receive the FAX, leading to the problem of a time out that causes the transmission of the FAX to be cut off partway through.

Although the present invention has been fully described by way of examples with reference to the accompanying drawings, it is to be noted that various changes and modifications will be apparent to those skilled in the art.

Therefore, unless otherwise such changes and modifications depart from the scope of the present invention, they should be construed as being included therein.

What is claimed is:

1. An image forming apparatus including an Application Specific Integrated Circuit (ASIC) provided with a first functional module and a second functional module that are reset together by a reset signal, the image forming apparatus comprising:
a memory for storing data used for processing by the first functional module and data used for processing by the second functional module;
an error detection unit configured to detect an error in the first functional module and an error in the second functional module;
a monitoring unit configured to monitor an execution state of the first functional module and an execution state of the second functional module;
a determination unit configured to acquire from the monitoring unit, when the error detection unit detects an error in only one of the first functional module and the second functional module, the execution state of the other functional module in which no error is detected, and to determine whether the other functional module is currently operating; and
a reset controller configured (i) to reset the ASIC by transmitting a reset signal to the ASIC when the determination unit determines that the other functional module is not currently operating, and (ii) to suppress resetting of the ASIC, when the determination unit determines that the other functional module is currently operating, until the other functional module finishes operating and, after the other functional module finishes operating, to reset the ASIC by transmitting a reset signal to the ASIC.

2. The image forming apparatus of claim 1, wherein
when the error detection unit detects an error in both the first functional module and the second functional module, the reset controller resets the ASIC by transmitting the reset signal to the ASIC without waiting for a result of determination by the determination unit.

3. The image forming apparatus of claim 1, wherein
when the determination unit determines that the other functional module in which no error is detected is currently operating, and subsequently an error is detected in the other functional module while the other functional module is continuing to operate, the reset controller stops suppressing resetting of the ASIC and resets the ASIC by transmitting the reset signal to the ASIC.

4. The image forming apparatus of claim 1, wherein
the first functional module is a compression module that compresses image data, and
the second functional module is an expansion module that expands compressed image data.

5. The image forming apparatus of claim 4, further comprising
a facsimile reception function, wherein
when an error is detected in the compression module and the expansion module is currently operating, and a fax arrives from an external source while the expansion module is continuing to operate, the reset controller stops suppressing resetting of the ASIC and resets the ASIC by transmitting the reset signal to the ASIC without waiting until the other expansion module finishes operating.
